(19) United States
(12) Patent Application Publication
(10) Pub. No.: US 2022/0142036 A1
(43) Pub. Date: May 12, 2022

(54) METHOD FOR DETERMINING THE TOPO-CLIMATIC CHARACTERISTICS OF A GEOGRAPHIC AREA

(71) Applicant: CARLO FERRETTI, Bolzano (BZ) (IT)

(72) Inventor: CARLO FERRETTI, Bolzano (BZ) (IT)

(21) Appl. No.: 17/430,929

(22) PCT Filed: Feb. 18, 2020
(86) PCT No.: PCT/IB2020/051334

§ 371 Date: Aug. 13, 2021

(30) Foreign Application Priority Data
Feb. 18, 2019 (IT) 102019000002359

(51) Int. Cl. A01B 79/00; A01C 21/00; A01G 22/00; G06Q 50/02; G06V 20/13; G06V 20/10; G06F 16/29

(52) U.S. Cl. CPC A01B 79/005; A01C 21/007; A01G 22/00; G06F 16/29; G06V 20/13; G06V 20/188; G06Q 50/02

(57) ABSTRACT

The complex topographic and climatic characteristics of a geographic area, or plot of land, are expressed by means of an index product (SRI) which allows to link such plot to the qualitative properties of a given agricultural product (P) or to a plant variety able to produce said agricultural product, for example a vine and a wine.

### SUMMARY OF THE INVENTION

Object of the present invention is a process for determining the topo-climatic characteristics of a geographic area. In particular, the invention concerns a method for determining the topo-climatic characteristics of an area used in agriculture and the use of such characteristics for producing an agricultural product in such geographic area, depending on the properties of a given agricultural product. The present invention is used in the field of geographical precision analyses and classifications of territories in the agricultural sector, in particular in the fruit and wine-growing and wine-producing sector. The invention will be described with reference to the cultivation of vines and to the production of wine, but can be applied to other cultivations, such as for example apples, cocoa and coffee, wherein the fruit possesses strong organoleptic characteristics that can be affected by the cultivation site.

### BACKGROUND OF THE INVENTION

It is known that the growth of plants and the quality of the products that can be obtained from them, in particular the growth of vines and the quality of wine, are affected by the topo-climatic conditions of the land where the plants are present. The term “topo-climatic condition” defines the set of topographical and climatic characteristics of the ground to be analyzed. A topo-climatic condition consists of numerous independent variables, such as slope, orientation, position and exposure, shading conditions, the position and zenithal height of the sun in the horizon, and which, as a whole, are thus understood as natural ecological resources of the territory. In particular, the surrounding valley slopes and mountain ridges, i.e. the geographic area being assessed, of a hilly and mountainous region affect its exposure to the sun, since they can provide many hours of shade during the day, thus depriving it of direct solar radiation in a variable way during the seasons.

The topo-climate is a complex and characteristic environmental variable of each cultivated plot that acts as a primary environmental regulator that increases the ecological diversity. In a vineyard, the topo-climate defines the energy condition of the plot by regulating its received solar radiation and temperature, which are both precursors of the biosynthetic activities that promote the productive and qualitative potential of the vine in terms of the aromas and typicality of the wine and agricultural product in general. Moreover, the topo-climate usually represents a stable geographic condition of the agricultural territory which, being unique along with the geopedology, remains constant over the years. These two elements define the natural identity of the vineyard and territory, thus affecting the quality of its products, also in terms of fruits, musts and wine.

In large or geographically complex territories, the elements forming the topo-climate vary significantly and could neither be qualified as a whole nor even compared quantitatively to one another prior to this invention. For example, just consider the topographical heterogeneity of large mountainous or hilly geographic areas, with the shade provided by the reliefs, or the presence of deep valleys, and the radiation variations linked to the different zenithal position of the sun with the seasons.

In other words, the different variable parameters, such as slope, orientation, position and exposure, shady areas and the zenithal position of the sun, was not be effectively and repeatably correlated as a whole. The connections between geography, microclimate and quality of the wine were thus not very accurate, sometimes not even scientifically demonstrable, and even imprecise or insufficient. A further problem resides in the fact that the values of the climate of a geographic area can vary over the years, much more rapidly than has hitherto been the case, due to the current climate changes.

There is thus the need to provide methods for analyzing and parameterizing the characteristics that contribute in defining the topo-climate of a cultivated plot or of a larger geographic area, so that to have univocal, repeatable and reliable values of reference that allow to make comparisons and qualitative assessments among different geographic areas for the same products and agricultural foods cultivated.

### OBJECTS OF THE INVENTION

Object of the present invention is to overcome the problems mentioned above and to provide a method for determining the topo-climatic identity of a geographic area, which is a functional characteristic of the properties of a given agricultural product, in particular of wine.

These and further objects can be achieved by the present invention by means of a method for determining the topo-climatic identity of a geographic area according to claim 1. The aforesaid method can be implemented by means of computerized means. In particular, the method of the invention can be carried out by means of instructions of a computer program configured to be executed by a generic data processing apparatus provided with a memory. Such data processing apparatuses can, for example, be incorporated in a personal computer, a smartphone or the like.

The invention further concerns a process for managing such geographic area by using said topo-climatic identity for producing agricultural products, such as defined according to claim 8. Preferred aspects are specified in the dependent claims.

The process adopted according to the present invention allows to qualify and certify the territorial elements that distinguish the “topo-climatic” geographic specificity of the plot cultivated and which is connected to the quality of the products of the agricultural food chain and to their origin, including the geographic indication and the designation of origin.

The process adopted according to the invention allows to achieve a precise classification of the territory in favor of its products, with the aim of defining the natural geographic identity of the cultivated plots and to thus be able to distinguish the original quality of its products, but also the potential value of the same cultivated plots so that to reach defined qualitative product standards.

The invention was tested and described in the sector of wine and wine-growing and wine-producing products, but its use can also be extended to other agricultural food realities and ecological varieties such as: apples, oranges, olives, pistachios, coffee, cocoa, etc. and derived food products.

A measuring and cataloging process that allows to combine the independent geographic variables forming the topo-climate into a single new index was thus devised. The new index is named “SRI”, acronym of Solar Radiation Identity (Index). The invention finds particular, but not exclusive, application in the characterization of wine lands. In a practical application, the index was tested for measuring the topo-climatic heterogeneity of more than 26,000 vineyards of the historic South Tirol wine region, over an overall cultivated surface of 5,450 hectares. In the specific case, it allows to assess and document the geographic potential of vineyards in favor of the ecological diversity, as well as the differences in the quality of the wine deriving therefrom, including the distribution of the vineyards and the quality of their products on the territory. The analysis of the SRIST value averaged between the vineyards of each MGA area completes the assessment of their geographic identity within the wine region.

The index conceived is aimed to certify the geographic specificity of the cultivated plot in its topo-climatic component, a natural element that is stable over the years but varies from place to place and seasonally, thus a characteristic which qualifies the originality of the cultivated plot, the territory in general and its products.

The process of determining the index is based on an accurate geospatial analysis of the territory (GSA—Geo Spatial Analysis), wherein the daily solar radiation is simulated and the value of potential direct and indirect radiation (defined “SR” Solar Radiation and expressed in kwh/mq) is measured for each single cultivated plot by applying applicative GIS programming tools. The SR is simulated for the entire duration of the vegetative period or for specific shorter periods, but which must anyhow have a biochemical and ecological significance for the plant and/or its fruits. The result is translated into a simpler numerical geographic “SRI” index, which represents a product of the invention.

According to an aspect of the invention, it is in fact provided to perform a simulated GSA analysis to estimate the potential direct and indirect solar radiation (SR) in said geographic position during said at least one cultivation time period (Q) of said agricultural product (P). In a further aspect of the invention, the radiation is at least in part punctually measured on site with appropriate sensors, the data is thus collected and possibly combined with that obtained from a simulation on a vast surface.

The steps of the method are preferably carried out for a plurality of geographic positions to achieve an SRI parameter representative of the geographic area and/or the selected agricultural product (P).

In an aspect of the invention, the geographic area is subdivided by means of a raster of cells having an extent selected as a function of the morphology of the territory and of the typology of said agricultural product. Preferably, the method further provides to carry out a weighted average of the topo-climatic parameters calculated.

The cultivation time period (Q) of the agricultural product (P) of the geographic area can comprise a vegetative growth period of the agricultural product and/or a sprouting period of the agricultural product and/or a maturation period of the agricultural product.

The method can thus provide the step of applying a mathematical function to said at least one topo-climatic parameter (SRIV, SRIS, SRIH) so that the value of said function refers to two given limit values, which define an absolute range of reference.

Preferably, the agricultural product is an agricultural food product and its properties are both the qualitative organic and organoleptic properties and those of the variety species' ability to adapt themselves to the topo-climatic condition under consideration, for example in terms of biodiversity or physiological evolution, maturation, pathologies, etc. It was in fact found that there are direct connections between the SRIV, the geographic position of the vineyards, the grape varieties, and the quality of their musts and wines; similar correlations exist between SRI and other agricultural products. In other words, once the SRI parameter of an agricultural product, for example wine, has been associated with the characteristics of one or more agricultural products or with different sets of characteristics of an agricultural product (for example wine), such parameter becomes an optimal tool to assess the characteristics of an agricultural product to be grown in the geographic area for which the SRI was elaborated.

FIGS. 5 and 6 show how two different SRIs can be associated with the same type of agricultural product (Pinot Nero wine for FIG. 5 and Sauvignon Blanc for FIG. 6) for both the Pinot Nero and the Sauvignon Blanc depending on the area of the vineyard. For example, for the Pinot Nero of the Mazon area, the organoleptic characteristics are different than those of the Pinot Nero from the Val Venosta area. Similarly for the Sauvignon Blanc of the Klaus and Penon-Kofi areas.

Thus, an embodiment of the invention provides to obtain an SRI parameter of each of a first plurality of geographic areas from a computer simulation, to associate said parameter with the physical characteristics (for example organoleptic and/or visual or the like) of an agricultural product cultivated in each of said areas, to obtain the SRI parameter of a second geographic area and to assess the physical characteristics that said agricultural product would have if cultivated in said second geographic area.

### BRIEF DESCRIPTION OF THE FIGURES

The invention will now be described in more detail with reference to the figures attached by way of example and without limitations, wherein:

FIG. 1 is a graphic representation of an SRI index;

FIG. 2 is a graphic representation of the numerical classification of a geographic area obtainable according to the method of the invention;

FIGS. 3 and 4 are 2D and 3D graphic representations, respectively, of the classification of a geographic area and its cultivated plots in a chromatic scale, as obtainable according to the method of the invention;

FIG. 5 is a graphic representation of a map of South Tirol showing the geographic areas of Val Venosta and Mazon and of a graph that clearly shows different values of the SRIV index for two different areas; and

FIG. 6 is a graphic representation of a map of South Tirol showing the geographic areas of Klaus and Penon-Kofi and of a graph that clearly shows the different values of the SRIH index for two different areas.

### DESCRIPTION OF THE INVENTION

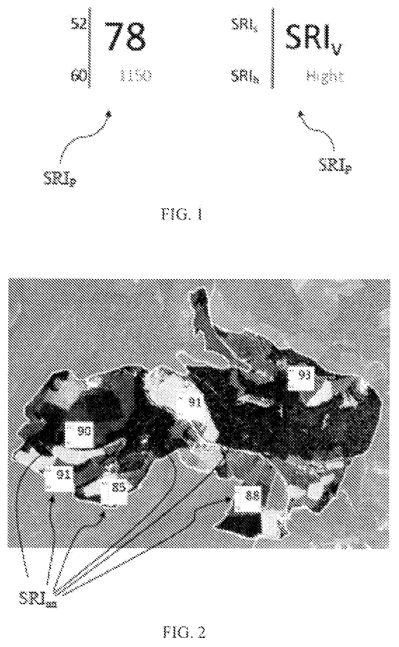

With reference to the attached FIGS. 1-4, the method of the invention provides to initially select a geographic position, for example a plot, such as a vineyard. Thus, a topo-climatic (SRIV, SRIS, SRIH) parameter is calculated with respect to the direct, diffuse and global solar radiation (SR) to which the soil is subjected in said geographic area during at least one cultivation time period Q of said agricultural product, for example a vine. As mentioned above, the SRI parameter can be obtained by means of a geospatial analysis of the territory (GSA) in which the value of potential direct and indirect radiation (defined “SR” and expressed in kwh/mq) is calculated for each single plot cultivated. A tool adapted for such simulation is, for example, the ArcGIS “Area Solar Radiation” (ESRI, 2015) tool which allows to calculate the amount of direct and indirect solar radiation received by the raster surfaces during a specific time period. The ArcGIS program is normally used to calculate, for example, the potential radiation on roofs for the installation of solar panels.

The previous step is preferably carried out by using data pertaining to the geological and morphological characteristics of the plot, thus inclination, orientation, height (asl altitude) and the sources of shade present on the plot. The geological and morphological data can be detected on site, in a way known in the art, or found in databases, if available. The SRI data obtained allows to associate at least one topo-climatic parameter (SRIv, SRIs, SRIH) calculated as above with said previously selected geographic position.

By applying a conventional graphical representation procedure described below, the main acronym SRI is coined together with variable subscript acronyms, which specify the territorial reference of the index. For example: SRₙₙ defines the characteristic range of the wine region, while SRI_{P} is the value referred to an agricultural product (a specific vineyard for example). SRI represents a numerical index value, for example between 0 and 100, defined according to a territorial standardization formula of the energy SR data, already calculated by the aforesaid GSA simulation. The SRIv index data is between the SRI (min) and SRI (MAX) values elaborated from the potential solar radiation received by the vineyard on the geographic territory being assessed, but is averaged for a number of raster cells which, together, form a significant surface for the analysis in progress. In the event of vineyards, for example, a significant area, consisting of a number of adjacent raster cells forming a useful surface together for the minimum production of a single wine batch, is considered.

Each cultivated plot or vineyard has its own topo-climatic identity defined with the process according to the invention. This must also be represented in a conventional way so that to be readable and compared among different places. For example, when considering a vineyard, SRI_{V} (V=vineyard) is the index referred to the entire vegetative period of the plant, SRI_{S} (S=sprout) and SRI_{H} (H=harvest) are respectively the values of the index for the sprouting, final maturation and harvesting periods of the fruit. Also the height represents a topo-climatic element to be represented in a conventional way.

The object of the invention is achieved by claim 1. Preferential embodiments are described in the dependent claims. The object is described below by referring, for explanatory simplicity, to the vineyard and wine, but the process according to the invention can also be linked to the growth and production of various agricultural food products.

The topo-climatic effects expressed by the SRI parameter according to the invention are clear in the test survey conducted in South Tirol. Direct connections between SRIv, the geographic position of the vineyards, the grape varieties, as well as the quality of their musts and wines, were observed. This invention according to the process allows to identify the optimal and excellent conditions, but also the critical ones for the growth of the vines, in the various varieties, and for the production of quality wine. The SRI index according to the invention shows that homogeneous portions of the territory and/or each single vineyard or cultivated plot can be correlated to the quality of its plants and its wines. When used alone or in combination with other geopedological, climatic and varietal elements, the invention supports the geographical selection of the vineyards with relation to the quality of the wine that the wine grower wishes to achieve and also assists in the search of ideal sites for new vineyards, or of the best grape varieties for planting, also in the perspective of reducing the vulnerability of the wine product in view of future climatic changes.

The invention provides practical help for the territorial subdivision provided by the wine regulations, and can also be used to recognize or enhance the wine areas intended for the production of quality agricultural foods.

The process according to the invention provides a tool of easy and concrete assistance for the analysis of the quality of wines and for the further development of wine practices. The invention allows to have a more precise cataloging of the territory in favor of its wine and its agricultural products. By applying the invention, producers and consumers can have clear scientific references available to assess and certify the original quality of the agricultural food products.

In an aspect, the invention allows to provide which plant varieties, vines for example, are most appropriate for being used in a given position or geographic area. Similarly, the process of the invention allows to provide the organoleptic characteristics of the wine obtained with a given variety of vines in the geographic position analyzed. The process for the production of agricultural products through the use of the SRI parameter described and discussed above comprises the following steps:

a. providing a database (DB) containing a plurality of agricultural products (P), wherein a classification index of the agricultural product (SRIP) comprising at least one topo-climatic parameter (SRIV, SRIS, SRIH), representative of the solar radiation to which the agricultural product is subjected during at least one cultivation time period (Q), is associated with each product, wherein said at least one cultivation time period (Q) is significant for the quality of the agricultural product (P);
b. selecting an agricultural product (P) to be cultivated from the database;
c. providing a map of a geographic area or a database of geo-referenced data, which comprises a plurality of geographic positions in which a territorial classification index (SRInn) comprising at least one corresponding topo-climatic parameter (SRIV, SRIS, SRIH) representative of the solar radiation to which this specific soil is subjected during said at least one cultivation time period of the agricultural product selected, is associated with each geographic position;
d. selecting at least one range of variability of the classification index of the agricultural product (SRIP) referring to two threshold values indicative of the degree of precision in the reproducibility of said agricultural product selected in said step (b), said range of variability being significant for the characteristics of the agricultural product;
e. determining at least one geographic position in said map so that the territorial classification index and the classification index of the agricultural product selected in said step (b) are referred to the range of variability selected in said step (d).

In an aspect of the invention, the classification index of the agricultural product (SRIP) further comprises the altitude (Height) at which the agricultural product (P) was cultivated and/or at least one geopedological parameter of the sediments composing the soil or sub-soil concerned by the root apparatus in which said agricultural product (P) was cultivated. The geopedological parameter comprises, for example, at least the basic aspects of the sediment that qualify its origin, stratigraphy, texture, mineralogical components of silicate and/or carbonate nature, as well as the aquifer condition.

As discussed above, an SRI parameter referred to at least one cultivation time period (Q), comprising a vegetative growth period of the agricultural product and/or a sprouting period of the agricultural product and/or a maturation period and/or another period anyhow significant for the bio-varietal particularities and with qualities of the agricultural product, is used.

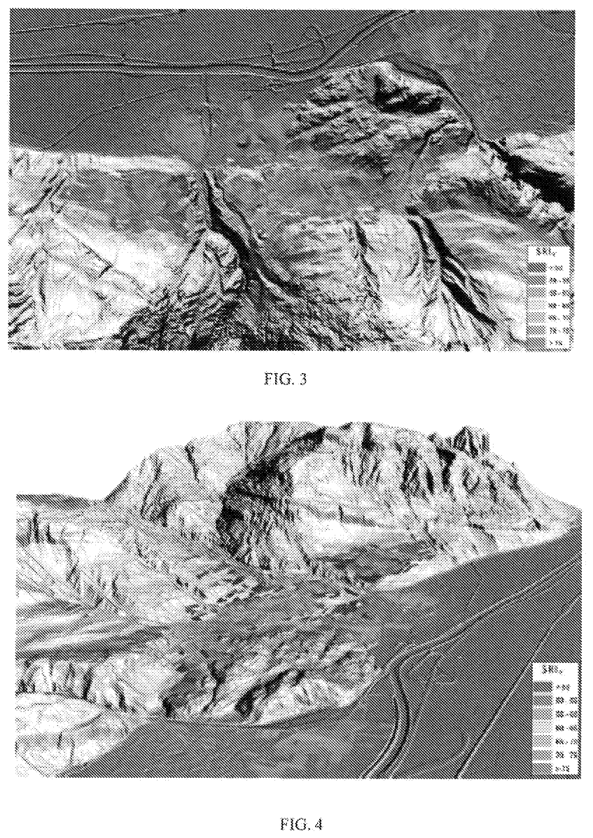

FIGS. 3 and 4 graphically represent indexes, i.e. SRI parameters obtained for a plurality of cultivated plots, i.e. of geographic positions in a geographic area.

In conclusion, the topo-climate of a plot of land is a multi-parametric element that varies according to the seasons. The analysis process and the algorithm of standardization according to the present invention rationalize the complex geographic data into a single product index (SRI) that is more adapted to meet the functional needs and purposes. The “product” of the invention consisting of the SRI index allows to link such plot or geographic area to the qualitative properties of a given agricultural product (P) or to a plant variety adapted to produce said agricultural product, for example a vineyard and a wine.

In other words, considering the example of the vine cultivation, the invention allows, once the SRI value of the vineyard being assessed has been determined and the variety of the vines cultivated therein are known, to be able to assess, i.e. determine, the organoleptic properties of the must or wine produced from such vineyard. The enologist technician can thus use the information to assemble different quantities of wines obtained from different vineyards, wines for which the characteristics are known, to achieve a wine with the desired characteristics. Similarly, the expert technician can use the information to select the best variety of vines to cultivate in the predetermined geographic position so that to obtain a wine with the desired characteristics.

FIG. 5, which is a graphic representation of a map of South Tirol showing the geographic areas of Val Venosta and Mazon and of a graph that clearly shows different SRIᵥ index values for two different areas, is depicted as a further example.

The enological characteristics of wines coming from these two different areas are different from one another. In particular it can be demonstrated that the concentrations of anthocyanins and tannins can be directly correlated to the geographic position of the respective vineyards because such concentrations are directly affected by the nature of the solar radiation. As emerges from FIG. 5, the SRIV index appears to be able to clearly distinguish the two areas.

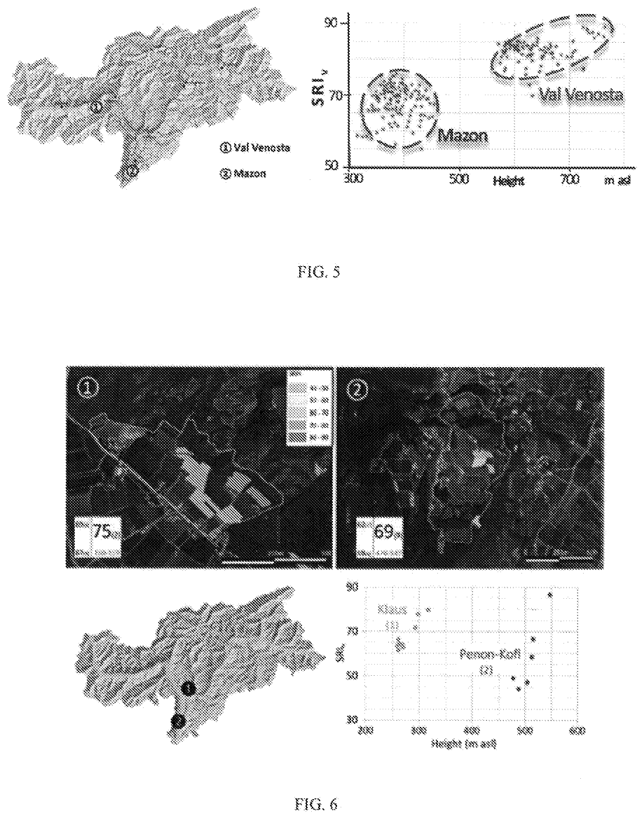

FIG. 6 is a graphic representation of a map of South Tirol showing the geographic areas of Klaus and Penon-Kofi and of a graph that clearly shows the different values of the SRIH index for two different areas.

Also in this case, the SRIH index is able to distinguish the different characteristics of the two areas assessed, i.e. in the case of the Penon-Kofi area, for example, at higher altitudes, lower values of the SRIH index can be noted.

1. Method for determining the topo-climatic identity of a geographic area, or plot, the aforesaid method being implemented by means of computerized means, the aforesaid method comprising the following steps:
(i) selecting a geographic position belonging to said geographic area;
(ii) performing a simulated GSA analysis to estimate the potential solar radiation (SR) in said geographic position during said at least one cultivation time period (Q) of said agricultural product (P);
(iii) calculating, by the aid of the aforesaid computerized means, at least one topo-climatic parameter (SRIV, SRIS, SRIH) as a function of the solar radiation (SR) to which the soil is subjected in said geographic position during at least one cultivation time period (Q) of said agricultural product (P);
(iv) associating said at least one topo-climatic parameter (SRIV, SRIS, SRIH) calculated in step (iii) with said geographic position selected in said step (i), said at least one topo-climatic parameter (SRIV, SRIS, SRIH) being indicative of the properties of said agricultural product.

2. Method according to claim 1, wherein said steps (i), (ii), (iii) and (iv) are carried out for a plurality of geographic positions belonging to said geographic area.

3. Method according to claim 2, comprising the step of subdividing said geographic area by means of a raster of cells having an extent selected as a function of the type of said agricultural product, and a step of carrying out a weighted average of the topo-climatic parameters calculated in said step (iii) as a function of the number of cells.

4. Method according to any one of the preceding claims, wherein said at least one cultivation time period (Q) of said agricultural product (P) comprises at least one time period selected between: a vegetative growth period of the agricultural product, a sprouting period of the agricultural product, a maturation period of the agricultural product, another significant period for the bio-varietal particularities and with qualities of the product.

5. Method according to any one of the preceding claims, comprising the step of applying a mathematical function to said at least one topo-climatic parameter (SRIV, SRIS, SRIH) so that the value of said function defines two given values of reference.

6. Method according to any one of the preceding claims, wherein said agricultural product is an agricultural food product, and wherein said properties of said agricultural product are organoleptic properties of said agricultural food product and/or the variety of said agricultural product.

7. Process for producing agricultural products characterized by comprising the following steps:
(a) providing a database (DB) containing a plurality of agricultural products (P), wherein a classification index of the agricultural product (SRIP) comprising at least one topo-climatic parameter (SRIV, SRIS, SRIH), representative of the solar radiation to which the agricultural product is subjected during at least one cultivation time period (Q), is associated with each product, wherein said at least one cultivation time period (Q) is significant for the quality of the agricultural product (P);
(b) selecting an agricultural product (P) to be cultivated from the database;
(c) providing a map of a geographic area or a database of geo-referenced data, which comprises a plurality of geographic positions in which a territorial classification index (SRInn) comprising at least one corresponding topo-climatic parameter (SRIV, SRIS, SRIH) representative of the solar radiation to which its soil is subjected during said at least one cultivation time period of the agricultural product selected, is associated with each geographic position;
(d) selecting at least one range of variability of the classification index of the agricultural product (SRIP) referring to two threshold values indicative of the degree of precision in the reproducibility of said agricultural product selected in said step (b), said range of variability being significant for the characteristics of the agricultural product;
(e) determining at least one geographic position in said map so that the territorial classification index and the classification index of the agricultural product selected in said step (b) are referred to the range of variability selected in said step (d); and
(f) cultivating said agricultural product (P) selected in said step (b) in said at least one geographic position determined in said step (e).

8. Process according to claim 7, wherein said classification index of the agricultural product (SRIP) further comprises the altitude (Height) at which said agricultural product (P) was cultivated and/or at least one geopedological parameter of the soil in which said agricultural product (P) was cultivated.

9. Process according to any one of preceding claims 7 to 8, wherein said step (a) comprises the step of performing a measure or a simulated GSA analysis of the potential solar radiation (SR) that strikes each single plot on which said agricultural product grows.

10. Process according to any one of preceding claims 7 to 9, wherein said step (c) comprises the step of performing a simulated GSA analysis to estimate the potential solar radiation of all cultivated homogeneous plots situated in said geographic area.

11. Process according to any one of preceding claims 7 to 10, wherein said at least one cultivation time period (Q) comprises a vegetative growth period of the agricultural product and/or a sprouting period of the agricultural product and/or a maturation period and/or another period anyhow significant for the bio-varietal particularities and with qualities of the agricultural product.

12. Process according to any one of preceding claims 7 to 11, wherein said plurality of agricultural products comprises a plurality of agricultural food products, preferably a plurality of vine or apple varieties.
